(19) United States
(12) Patent Application Publication
(10) Pub. No.: US 2008/0008109 A1
(43) Pub. Date: Jan. 10, 2008

(54) Method and apparatus for bridging wireless control networks

(76) Inventor: Jeffrey Ollis, Dresher, PA (US)

Correspondence Address: PATTERSON & SHERIDAN, LLP;MOTOROLA, INC., 595 SHREWSBURY AVENUE, SUITE 100, SHREWSBURY, NJ, 07702, US

(21) Appl. No.: 11/232,351

(22) Filed: Sep. 21, 2005

Related U.S. Application Data
(60) Provisional application No. 60/611,634, filed on Sep. 21, 2004.

(51) Int. Cl. H04B 7/00

(52) U.S. Cl. 370/310

(57) ABSTRACT

An aspect of the invention relates to a method and apparatus for the communication between a first wireless control network and a second wireless control network. In one embodiment, a message from a second network node in the second wireless control network that is intended for a first network node located in the first network is received. The message is addressed to an address in a second address space of the second wireless control network for the first network node. The address is then translated in order to determine another address that exists in a first address space of the first wireless network for the first network node. Lastly, the message is transmitted to the first network node using the other address.

### CROSS-REFERENCE TO RELATED APPLICATIONS

This application is claims benefit of U.S. Provisional Patent Application Ser. No. 60/611,634, filed Sep. 21, 2004, which is incorporated by reference herein in its entirety.

### BACKGROUND OF THE INVENTION

1. Field of the Invention

Embodiments of the present invention generally relate to wireless control networks. More specifically, the present invention relates to a method and apparatus for bridging wireless control networks.

2. Description of the Related Art

Currently, wireless control networks are utilized in various industries in order to control and monitor devices at a particular location or plurality of locations. For instance, wireless control networks may be employed to control devices, such as light switches, temperature sensors, smoke detectors, environment controls, and the like within a building. Such networks are typically exhibit low data rates and low power consumption. ZIGBEE is an emerging standard for such wireless control networks. Briefly stated, the ZIGBEE standard is based on the IEEE 802.15.4 physical radio standard. The ZIGBEE standard defines the network, security, and application framework profile layers for an IEEE 802.15.4-based system. Devices in a ZIGBEE network operate in unlicensed bands at 2.4 GHz (globally), 915 MHz (Americas), and 868 MHz (Europe). Raw data throughput rates of 250 Kbs can be achieved at 2.4 GHz (16 channels), 40 Kbs at 915 Mhz (10 channels), and 20 Kbs at 868 MHz (1 channel). Transmission distances range from 10 to 100 meters, depending on power output and environmental characteristics. A network of devices in a ZIGBEE system is referred to as a personal area network (PAN).

In some applications, the ability to control several buildings or locations in this manner is occasionally required. However, current wireless control network technologies have a limited address space, which limits the number of devices in the network. In ZIGBEE, for example, a PAN can only support around 65,535 devices due to addressing constraints. As the number of devices that need to be controlled increases (e.g., due to the number of buildings that may need to be managed), it is less likely that current wireless control network technologies will be able to accommodate the demand.

Thus, there is a need in the art for a more effective method and apparatus for controlling and monitoring wireless control networks.

### SUMMARY OF THE INVENTION

An aspect of the invention relates to a method and apparatus for the communication between a first wireless control network and a second wireless control network. In one embodiment, a message from a second network node in the second wireless control network that is intended for a first network node located in the first network is received. The message is addressed to an address in a second address space of the second wireless control network for the first network node. The address is then translated in order to determine another address that exists in a first address space of the first wireless network for the first network node. Lastly, the message is transmitted to the first network node using the other address.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system of bridged personal area networks;

FIG. 2 depicts a block diagram of a system of bridged personal area networks that incorporates a virtual personal network;

FIG. 3 depicts a method for communicating with a network device via a bridge device;

FIG. 4 illustrates a method for registering a node for inter-PAN communication;

FIG. 5 illustrates a method for communicating with a node in a Super-PAN network via a bridge device; and

FIG. 6 depicts a high level block diagram of a general purpose computer suitable for use in performing the functions described herein.

To facilitate understanding, identical reference numerals have been used, wherever possible, to designate identical elements that are common to the figures.

### DETAILED DESCRIPTION

Method and apparatus for bridging wireless control networks is described. For purposes of clarity by example, one or more aspects of the invention are described with respect to ZIGBEE control networks (i.e., PANs), which have a limited address space. Those skilled in the art will appreciate that the present invention may be used with other types of wireless control networks known in the art, including other types of low data rate wireless control networks, wireless control networks based on IEEE 802.15.4, and ZIGBEE-like networks. In addition, embodiments of the invention may have broader application using other wireless networks, such as IEEE 802.11 (a,b and g), BLUETOOTH, and the like.

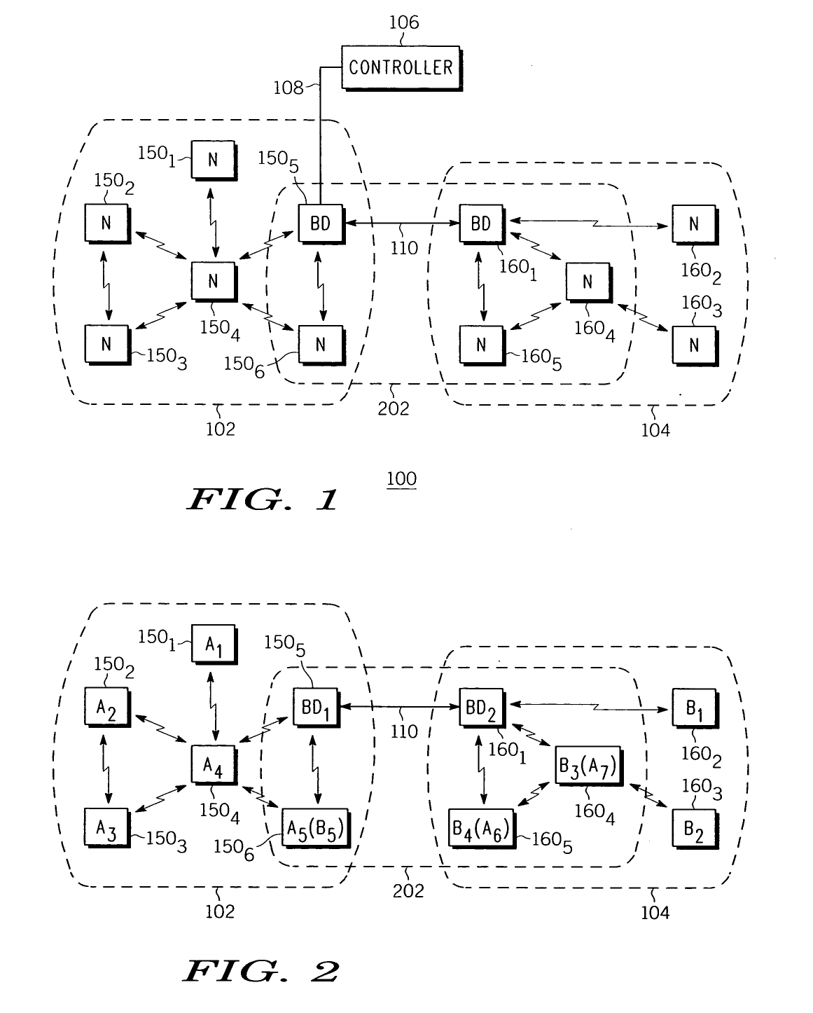

FIG. 1 illustrates an exemplary network 100 that comprises two personal area networks (PANs) 102 and 104. Although only the PAN 102 and the PAN 104 are shown by way of example, those skilled in the art recognize that additional PANs may be incorporated in the network 100. Depending on the embodiment, the PAN 102 and the PAN 104 may either be situated in a common building or located in separate buildings. The PAN 102 includes a plurality of nodes, illustratively, nodes 150₁ through 150₆. The PAN 104 includes a plurality of nodes, illustratively, nodes 160₁ through 160₅. Each PANs 102 and 104 has a network topology. For example, the ZIGBEE standard supports star, mesh (peer-to-peer), and cluster tree (a hybrid star/mesh) network topologies.

For each PAN, each of the nodes may be classified generally as either a primary node or secondary node. A primary node is a fully functional network component that can function in any network topology and can communicate with any other device (e.g., a network coordinator or controller). A secondary node is a network component that is limited to a specific network topology (e.g., star) and can only communicate with primary nodes (e.g., a temperature sensor). In ZIGBEE parlance, a primary node is a full function device and a secondary node is a reduced function device. For example, the PAN 102 has a cluster tree topology, where the nodes 150₂, 150₃, 150₄, and 150₅ are primary nodes, and the nodes 150₁ and 150₆ are secondary nodes. The PAN 104 has a cluster tree topology, where the nodes 160₁ and 160₄ are primary nodes, and the nodes 160₂, 160₃, and 160₅ are secondary nodes. The PANs 102 and 104 are merely illustrative, as a typical PAN may include many more secondary devices.

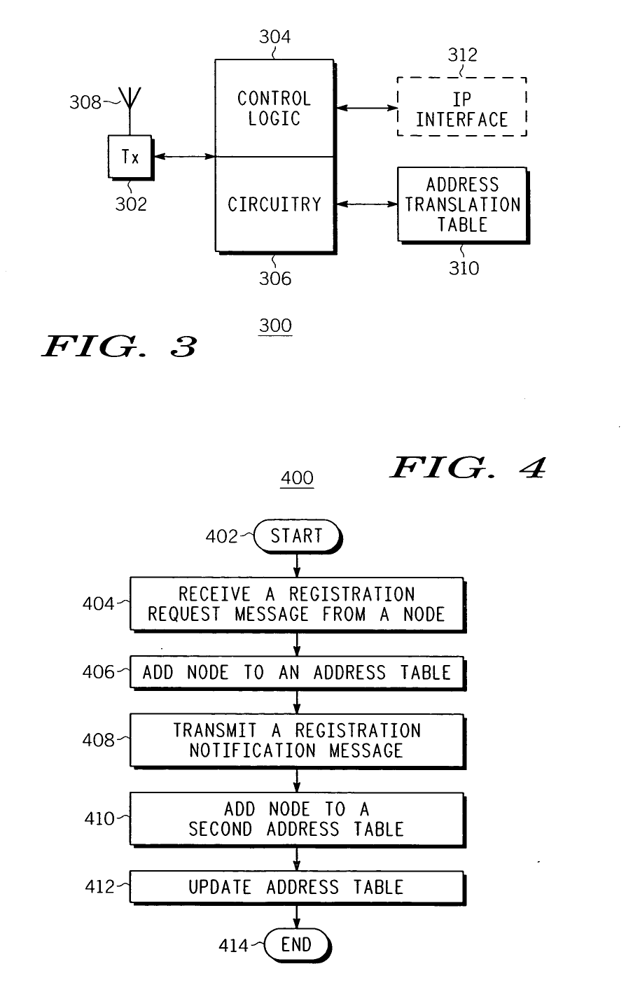

FIG. 3 is a block diagram depicting an exemplary embodiment of a node 300 in a PAN. In one embodiment, the node 300 includes a transceiver 302, control logic 304, and application specific circuitry 306. The transceiver 302 is configured to send and receive wireless signals via an antenna 308. For example, in a ZIGBEE network, the transceiver 302 may be a radio compliant with IEEE 802.15.4. Such radios are well-known in the art. The application specific circuitry 306 can be any type of circuitry being controlled, such as light switches, environmental controls, and the like. The control logic 304 is configured to control the transfer of messages between the application specific circuitry 306 and the transceiver 302. Notably, the control logic 304 implements the protocol used for communication in the network (i.e., the protocol stack). The messages may include control data, measurement data, and the like.

Returning to FIG. 1, in the present example, the node 150₅ and the node 160₁ are bridge devices. A bridge device enables a node in one PAN to communication with a node in another PAN, i.e., inter-PAN bridging. In a given PAN, a bridge device is configured for communication with at least one other bridge device in another PAN or PANs. In the present example, the bridge node 150₅ is coupled to the bridge node 160, via a communication link 110. The communications link 110 is typically a wire, a cable, fiber optic line, or the like since the two bridge devices are normally separated by a significant distance (e.g., separate buildings). However, the communications link 110 may be a wireless link (e.g., if the bridge devices are relatively near each other, depending on the particular wireless system used). Communication between the PAN 102 and the PAN 104 is facilitated using bridge devices 150₅ and 160₁. For purposes of clarity by example, each of the bridge devices 150₆ and 160₁ is shown as being in communication with a single bridge device. It is to be understood, however, that either of the bridge devices 150₆ and 160₁ may be in communication with other bridge devices in the PANs shown or in other PANs.

A Super-PAN is a combination of all devices in a given PAN (e.g., the PAN 102), as well as those devices from other PAN(s) that are identified for inter-PAN communication. In the ZIGBEE network environment, a PAN is limited to 65,535 devices or nodes (i.e., the nodes have 16-bit addresses and the address space of the PAN is 65,535 addresses). Like a PAN, the size of a Super-PAN is also limited such that the number of devices in the local PAN plus the number of remote devices in remote PAN(s) cannot exceed 65,535 total devices. If there are fewer than 65,535 total devices in all of the PANs of the network 100 that are to be combined via Inter-PAN bridging, then all of the devices may be included within a common Super-PAN and be capable of communicating through linked bridge devices. However, if there are more than 65,535 devices in the combined PANs, only a subset of the total number of devices from each PAN may be selected form a given Super-PAN.

In the example of FIG. 1, the nodes in the PAN 102 and the nodes 160₁, 160₄, and 160₅ of the PAN 104 form a Super-PAN from the perspective of the PAN 102. Likewise, the nodes in the PAN 104 and the nodes 150₅ and 150₆ of the PAN 102 form a Super-PAN from the perspective of the PAN 104. In essence, the nodes 150₅ and 150₆ of the PAN 102, and the nodes 160₁, 160₄, and 160₅ of the PAN 104, form a virtual network 202. A Super-PAN essentially enables a remote device to appear as a local device on a given PAN. Thus, a local device in a local PAN may send a message to a remote device in a remote PAN if the local device and the remote device are part of the same Super-PAN.

In particular, the bridge nodes 150₅ and 160₁ each include an address translation table that maps Super-PAN addresses to local PAN addresses. This may be achieved by utilizing the separate address spaces of PAN 102 and PAN 104. An address space may be defined as a set of possible addresses in a given PAN (e.g., 65,535 addresses in a ZIGBEE network). Therefore, nodes that have been selected for inter-PAN communication (i.e., devices within virtual network 202) are associated with addresses from multiple address spaces (e.g., node 150₆). Thus, if the node 300 of FIG. 3 is a bridge device, the node 300 includes an address translation table 310. The address translation mechanism may be understood with reference to the example shown in FIG. 2. FIG. 2 is a block diagram depicting the network 100 of FIG. 1 with address values for the nodes of the PAN 102 and the PAN 104. In particular, the nodes 150₁ through 150₄ and 150₆ have addresses A₁ through A₅, respectively. The nodes 160₂ through 160₅ have addresses B1 through B4, respectively. The address of the bridge node 150₅ is BD₁, and the address of the bridge device 160₁ is BD₂. In one embodiment, the bridge nodes include an IP interface, and thus have IP addresses in addition to PAN addresses.

From the perspective of the PAN 102, the node 160₅ has an address of A6 and the node 160₄ has an address of A7 in the address space of the PAN 102. These addresses are indicated parenthetically next to their local addresses. From the perspective of the PAN 104, the node 150₆ has an address B5 in the address space of the PAN 104. Addresses A6, A7, and B5 are Super-PAN addresses. As described below, Super-PAN addresses are registered with the PANs by the bridge devices. The bridge node 150₅ maps the Super-PAN address B5 to the local address A5. The bridge node 160₁ maps the Super-PAN addresses A6 and A7 to local address B4 and B3, respectively. If the node 160₄ desires to send a message to the node 150₆, the message is addressed to B5 in the address space of the PAN 104. That is, the node 160₄ (as wells as the other nodes 160₅, 160₂, and 160₃) is only “aware” of addresses in the address space of the PAN 104. The node 160₄ broadcasts the message, which is received by the bridge device 160₁. The bridge device 160₁ forwards the message to the bridge device 150₅ over the communication link 110. The bridge device 150₅ translates the address B5 in the address space of the PAN 104 into the local address A5 in the address space of the PAN 102, and forwards the message to the node 150₆ having the address A5.

In particular, a Super-PAN is formed by at least two bridge devices (e.g., the bridge nodes 150₅ and 160₁), which belong to separate PANs and are able communicate with each other. In order to add a node to a Super-PAN, the node must first be registered. FIG. 4 illustrates a method 400 for registering a node for inter-PAN communication. Method 400 begins at step 402 and proceeds to step 404, where an initial registration request message is received. In one embodiment, a bridging device (e.g., bridging device 150₅) in a local PAN (e.g., PAN 102) receives a local registration request from a local node (e.g., 150₆).

At step 406, the requesting node is added to an address table. In one embodiment, the bridging device accepts the registration request and provides an address to the requesting node in the address space of the local PAN (e.g., address A5 to the node 150₆). The addresses of all devices in a given PAN are stored in a PAN table, which may be maintained by the bridge device or by another device in the network (e.g., the PAN coordinator).

At step 408, a registration notification message is transmitted to at least one remote bridge device in a respective at least one remote PAN. For example, after registration at step 406, the bridge device may determine whether any remote PANs are configured to communicate with the requesting node (e.g., the node 150₆). If so, the bridge device sends a registration notification message, along with the requesting node's local address, to bridge device(s) of PAN(s) requesting access thereto (e.g., the bridge device 160₁ of the PAN 104).

At step 410, the node is added to a second address table. More specifically, a remote bridge device (e.g., the bridge device 160₁) in a remote PAN (e.g., the PAN 104) assigns a Super-PAN address (e.g., address B5) in the address space of the remote PAN (e.g., the PAN 104) to the requesting node. The remote bridge device adds the local address of the requesting node (e.g., address A5), the Super-PAN address (e.g., address B5), and an address of the bridge device of the PAN having the requesting node (e.g., the bridge device 150₅) to its address translation table. In one embodiment, the bridge devices are configured for communication using IP and the bridge device address is an IP address. Although located in a remote PAN in relation to PAN 104, node 150₆ appears to be local to PAN 104 due to its Super-PAN address, B5. Furthermore, those skilled in the art will realize that bridge devices in other remote PANs that are part of the Super-PAN will register the requesting node with their PANs, as described above.

At step 412, the address table of bridge device in the local PAN is updated. Notably, bridge device in communication with the requesting node receives notification of the Super-PAN address of the requesting node from the remote bridge device. Consequently, the bridge device in the PAN of the requesting node adds this data to its own address translation table for later reference. The method 400 then ends at step 414.

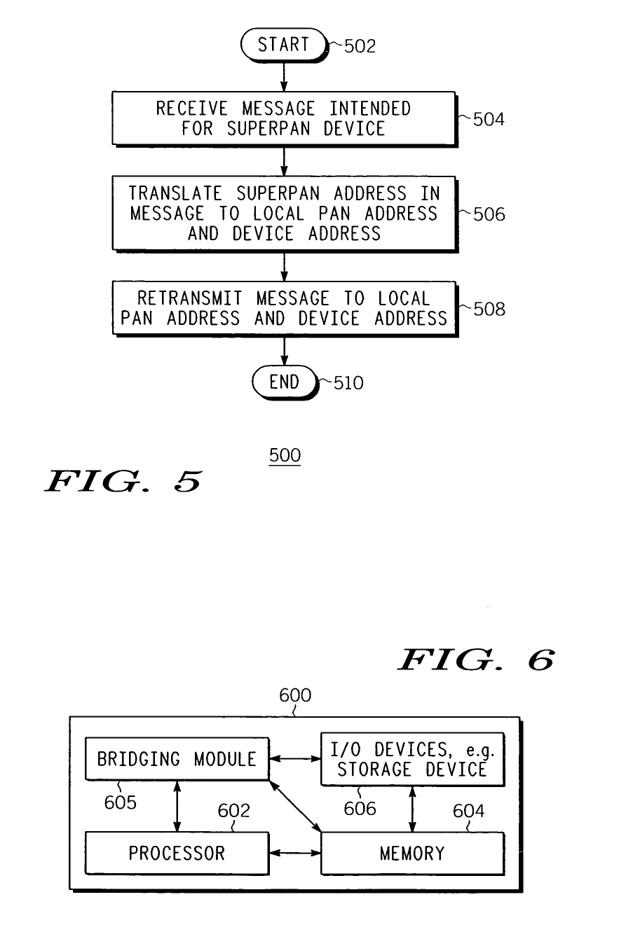

Once registered, a node is then capable of communicating with the other nodes within the Super-PAN. FIG. 5 illustrates a method 500 for communicating with a node in a Super-PAN network via a bridge device. Method 500 begins at step 502 and proceeds to step 504, where a signal message intended for a node in a Super-PAN is received. For example, the bridge device 150₅ may receive a request message from node 160₃ (via bridge device 160₁) in PAN 104 to communicate with node 150₆ in PAN 102. In one embodiment, this request message is broadcasted by node 160₃. Since these nodes are both in the same Super-PAN, communication is possible through bridge device 150₅ and bridge device 160₁.

At step 506, the Super-PAN address contained in the transmitted signal message is translated to a local PAN address. In one embodiment, the bridge device 150₅ acquires the Super-PAN address of the node to be contacted (e.g., node 150₆) from the received signal message. The bridge device 150₅ then compares the Super-PAN address with an address translation table (which maps Super-PAN addresses with local PAN addresses) in order to ascertain the corresponding local PAN address of the intended node device 150₆. In another embodiment, bridge device 160₁ may perform the translation procedure and then forward the message intended for the node 150₆ to bridge device 150₅. In one example of the network, the translation procedure involves a bridging device receiving a message with a first address and subsequently overwriting the first address with a second address obtained from an address translation table.

At step 508, the signal message is retransmitted to the local PAN address of the intended node. In one embodiment, the bridge device 150₅ forwards the signal message to the local PAN address and device address. The method 500 then ends at step 510.

In one embodiment, a bridge device may be equipped with both an Internet Protocol (IP) interface and a radio interface. Thus, the node 300 in FIG. 3 may also include an IP interface 312. The IP interface 312 may be a TCP/IP and UDP/IP interface. The bridge device is capable of receiving an IP message from a node of the PAN 102 or other device (e.g., a controller 106). For example, the controller 106 may only have an IP interface. The controller 106 may be any type of personal computer or processor that acts as a main control terminal that coordinates, monitors, and controls the nodes in at least one PAN. The communication link 108 between the controller 106 and bridge device 150₅ device may comprise a wired medium (e.g., cable or fiber optic line) or a wireless connection. The bridge device translates the IP message (e.g., a message having an IP format) for radio transmission (e.g., a message having a wireless control format) to the intended node. Likewise, the bridge device is capable of receiving a radio message from a node and translating the radio message to an IP message, which may be provided to the controller 106.

FIG. 6 depicts a high level block diagram of a general purpose computer 600 suitable for use in performing the functions described herein. In particular, the computer 600 may be used to implement a bridge device in a PAN. As depicted in FIG. 6, the system 600 comprises a processor element 602 (e.g., a CPU), a memory 604, e.g., random access memory (RAM) and/or read only memory (ROM) and/or persistent memory (Flash), a bridging module 605 (which performs the bridging function of the bridge devices in FIGS. 1 and 2, as described above), and various input/output devices 606 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the bridging module or process 605 can be loaded into memory 604 and executed by processor 602 to implement the functions as discussed above. As such, the present bridging module 605 (including associated data structures) of the present invention can be stored on a computer readable medium or carrier, e.g., RAM memory, magnetic or optical drive or diskette and the like

While the foregoing is directed to embodiments of the present invention, other and further embodiments of the invention may be devised without departing from the basic scope thereof, and the scope thereof is determined by the claims that follow.

1. A method for communication between a first wireless control network and a second wireless control network, comprising:
receiving a message from a second network node in said second wireless control network intended for a first network node located in said first wireless control network, wherein said message is addressed to an address in a second address space of said second wireless control network for said first network node;
translating said address to determine another address in a first address space of said first wireless control network for said first network node; and
transmitting said message to said first network node using said other address.

2. The method of claim 1, wherein said message is received at a first bridge device in said first wireless control network, wherein said second network node comprises a second bridge device.

3. The method of claim 2, wherein said second bridge device receives said message from a third network node in the second wireless control network.

4. The method of claim 1, wherein said first wireless control network and said second wireless control network are ZIGBEE personal area networks.

5. The method of claim 2, further comprising:
sending a registration message to said second bridge device for first network node;
recording said address for said first network node in an addressable translation table of the second bridge device in response to said registration message; and
associating said address with said other address in an address table of said first bridge device.

6. The method of claim 1, wherein said message received from said second network node comprises an encapsulated Internet Protocol (IP) format and wherein said method further comprises translating said encapsulated IP format from said second network node to a wireless control format.

7. The method of claim 1, wherein said translating step is executed using an address translation table.

8. A system for communication between a first wireless control network and a second wireless control network comprising:
a first bridge device in said first wireless control network for transmitting a message towards a network node in said second wireless control network, wherein said message is addressed to an address in an address space of said first wireless control network for said network node;
a second bridge device in said second network for receiving said message intended for said network node, translating said address to determine another address in a second address space of said second network for said network node, and transmitting said message to said network node using said other address.

9. The system of claim 8, further comprising a communication link between said first bridge device and said second bridge device.

10. The system of claim 8, further comprising another network node for transmitting said message to the first bridge device.

11. The system of claim 8, wherein each of said first wireless control network and said second wireless control network comprises a ZIGBEE network.

12. The system of claim 8, wherein said network node includes:
a receiver for receiving said message; and
application specific circuits for processing said message.

13. The system of claim 8, wherein an address translation table is used for translating between said first address space and said second address space.

14. A computer readable carrier including program instructions that instruct a computer to perform a method for communicating between a first wireless control network and a second wireless control network, comprising:
receiving a message from a second network node in said second wireless control network intended for a first network node located in said first wireless control network, wherein said message is addressed to an address in a second address space of said second wireless control network for said first network node;
translating said address to determine another address in a first address space of said first wireless control network for said first network node; and
transmitting said message to said first network node using said other address.

15. The computer readable carrier of claim 14, wherein said message is received at a first bridge device in said first wireless control network, wherein said second network node comprises a second bridge device.

16. The computer readable carrier of claim 15, wherein said second bridge device receives said message from a third network node in the second wireless control network.

17. The computer readable carrier of claim 14, wherein said first wireless control network and said second wireless control network are ZIGBEE personal area networks.

18. The computer readable carrier of claim 15, further comprising:
sending a registration message to said second bridge device for first network node;
recording said address for said first network node in an addressable translation table of the second bridge device in response to said registration message; and
associating said address with said other address in an address table of said first bridge device.

19. The computer readable carrier of claim 14, wherein said message received from said second network node comprises an encapsulated Internet Protocol (IP) format and wherein said computer readable carrier further comprises translating said encapsulated IP format from said second network node to a wireless control format.

20. The computer readable carrier of claim 14, wherein said translating step is executed using an address translation table.
